(19) United States
(12) Patent Application Publication
(10) Pub. No.: US 2005/0051017 A1
(43) Pub. Date: Mar. 10, 2005

(54) Punching device with replaceable punching die background of the invention

(76) Inventor: Yang-Ming Weng, Buu Yan Hsiang (TW)

Correspondence Address: CHARLES E. BAXLEY, ESQ., 90 JOHN STREET, THIRD FLOOR, NEW YORK, NY, 10038, US

(21) Appl. No.: 10/932,360

(22) Filed: Sep. 1, 2004

(30) Foreign Application Priority Data
Sep. 10, 2003 (TW) 092218070

(51) Int. Cl. B26D 5/08; B26F 1/14

(52) U.S. Cl. 83/694; 83/588; 83/687

(57) ABSTRACT

The present invention relates to a punching device with replaceable punching die, in which, a punching die can be easily replaced since it can be freely taken out of or assembled in a basement and an inserting frame of the punching device without difficulties. Thereby, the consumer can buy plural punching dies with lower cost, and then choose a suitable punching die, based on real needs, to cooperate with the basement.

### BACKGROUND OF THE INVENTION

1. Field of the Invention

The present invention relates to a punching device with replaceable punching die, and more particularly to a punching die equipped with easy-replaceable punching die.

2. Description of the Prior Arts

Referring to FIG. 1 (according to TW Patent No. 472,653), which shows a conventional punching device capable of creating various patterns on paper, such as animal, flower, characters or the likes. This kind of punching device is able to create versatile patterns with easy operation, so it is very popular with the lovers of arts and widely used in kindergarten.

The conventional punching device 10 in FIG. 1 is practical in design, however, the compression member 11 of which is hard to be pressed in operation. It needs a great punching force for a user to create a complete pattern (the punching hole or pattern cannot be cut off the paper if the pressing force is not great and even enough). Children seldom use this conventional punching device since their force is limited. To overcome this problem, another type conventional punching device 10 was developed in the industrial sector as shown in FIG. 2 (TW Patent No. 261,900), which is equipped with a compressing bar 12 based on level principle. The operation will be labor-saved and stress applied on the pattern knife in the punching device 10 will be even, so it is easy for a child to use.

However, it is to be noted that the protruded compression bar is a potential danger since the lovely and active child may be stabbed. Furthermore, it is also not economical for the industrial world since the cost will be increased about ⅓ by the extra compression bar.

For the users, it is relatively expensive to buy several punching devices since they need to create different patterns with different punching devices.

On the other hand, the conventional punching device needs other auxiliary tools' help to keep the punching holes in alignment, such as the straight scale. Thereby, the operation is not easy.

The present invention has arisen to mitigate and/or obviate the afore-described disadvantages.

### SUMMARY OF THE INVENTION

The primary object of the present invention is to provide a punching device with replaceable punching die, in which, a punching die can be easily replaced since it can be taken out of or assembled in a basement and the inserting frame without difficulties. Thereby, the consumer can buy plural punching dies with lower cost, and then choose a suitable punching die, based on real needs, to cooperate with the basement.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective view of a conventional direct-compression-type punching device;

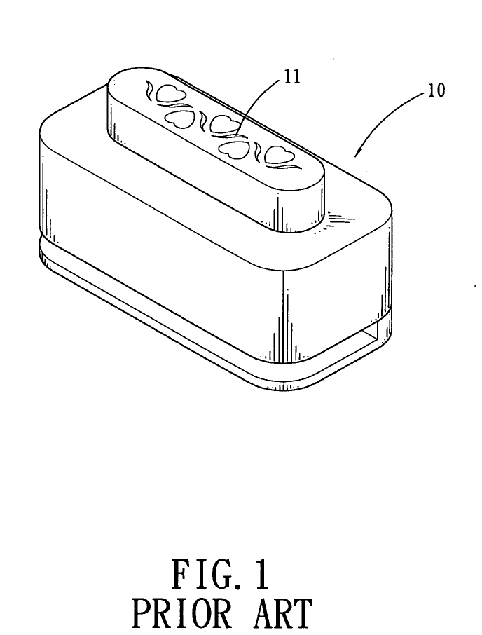

FIG. 2 is a perspective view of a conventional lever-compression-type punching device;

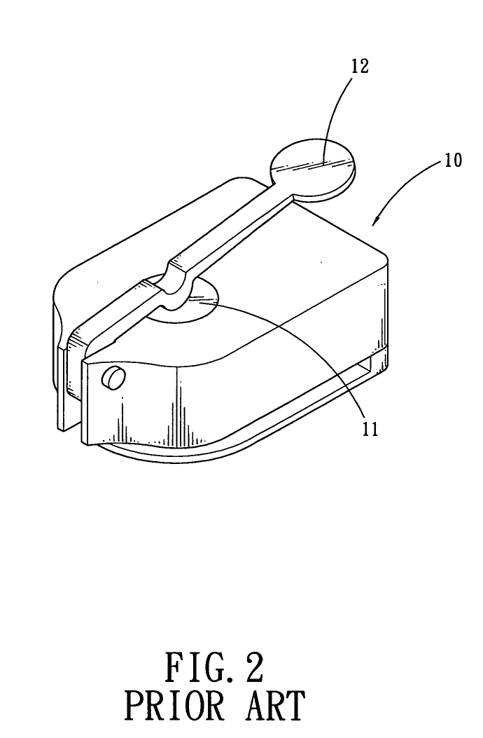

FIG. 3 is an exploded view of a punching device with replaceable punching die in accordance with the present invention;

FIG. 4 is a perspective cross sectional view of a punching device with replaceable punching die in accordance with the present invention;

FIG. 5 is a partial perspective view of a punching device with replaceable punching die in accordance with the present invention;

FIG. 6 is an operational view of a punching device with replaceable punching die in accordance with the present invention;

FIG. 7 is an illustrative view for showing the operation of replacing the punching die.

### DETAILED DESCRIPTION OF THE PREFERRED EMBODIMENT

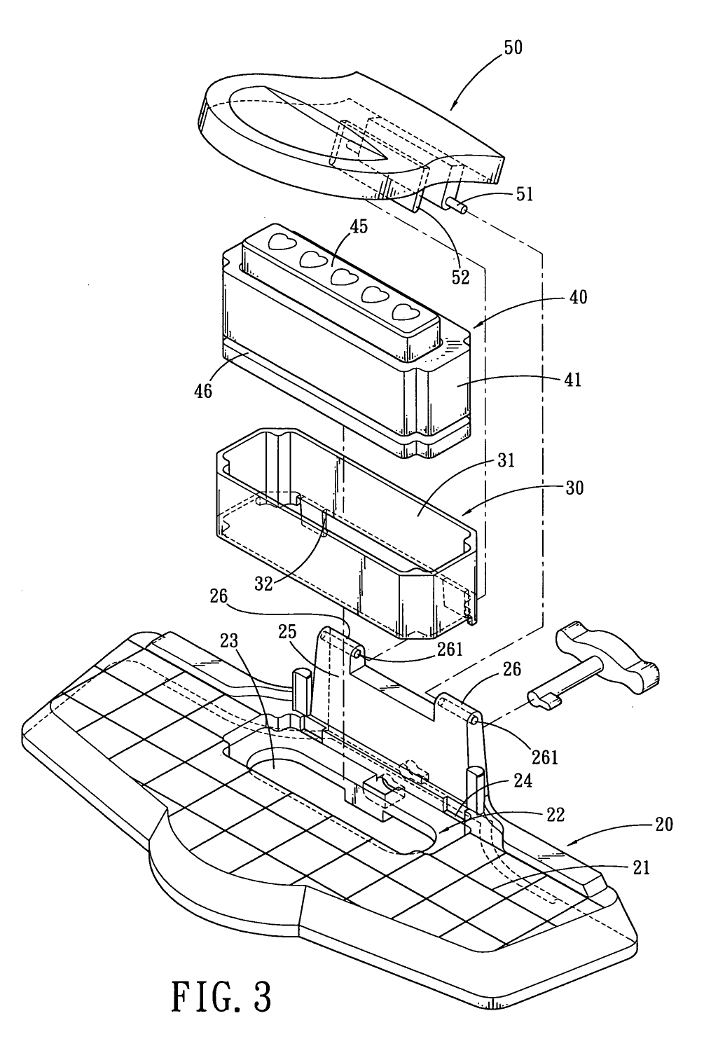

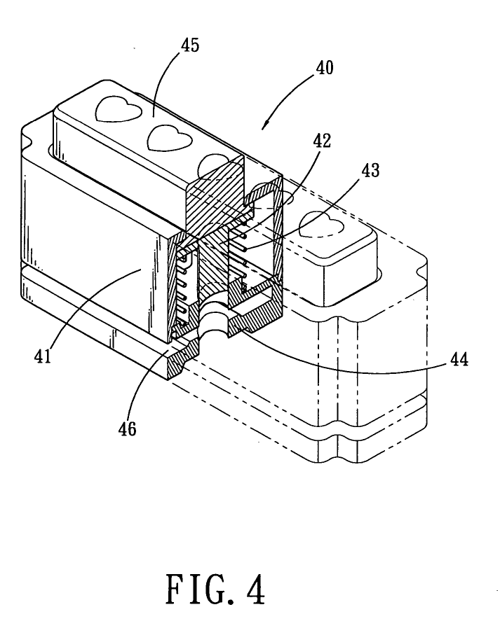

Referring to FIGS. 3-5, a punching device with replaceable punching die in accordance with the present invention is shown and generally comprising: a basement 20, an inserting frame 30, a punching die 40 and a compression bar 50.

The basement 20, a side of which can be a measurement plane 21 that is printed with gauge marks for measuring purpose. A recess 22 is formed on the measurement plane 21, in the recess 22 is formed with a through hole 23 and an inserting hole 24. A side of the basement 20 adjacent to the recess 22 is provided with an assembly portion 25, and a pair of ears 26 are respectively formed on both ends of the top edge of the assembly portion 25, each of the ears 26 is formed with an aperture 261.

The inserting frame 30 is a through frame having two open ends, the peripheral wall 31 of which correspondingly inserts in the recess 22 of the basement 20, the hooks 32 formed at the lower end of the inserting frame 30 are inserted in the inserting hole 24, and through plural legs 34 formed on a side of the lower end of the inserting frame 30 a space 33 is formed between another side of the lower end of the inserting frame 30 and the basement 20.

The punching die 40 is sequentially provided in an outer shell 41 with a pattern knife 42, a spring 43 and a die bed 44. A compression member 45 is disposed on the top surface of the pattern knife 42 and partially protruded out of the outer shell 41. A side of the outer shell 41 is formed with a feeding hole 46, via which, the paper can be inserted to the space between the pattern knife 42 and the die bed 44. The punching die 40 can be accommodated in the inserting frame 30, and the die bed 44 is aligned to the through hole 23 inside the recess 22.

The compression bar 50 is respectively provided at both sides with a shaft 26 that is used to insert in the ears 26 of the basement 20, and a compression rib 52 at the bottom surface of the compression bar 50 abuts against the top surface of the compression member 45.

Based on the above-mentioned assembly relationships between the respective components, the punching device in accordance with the present invention, besides capable of easily punching, can be quickly replaced.

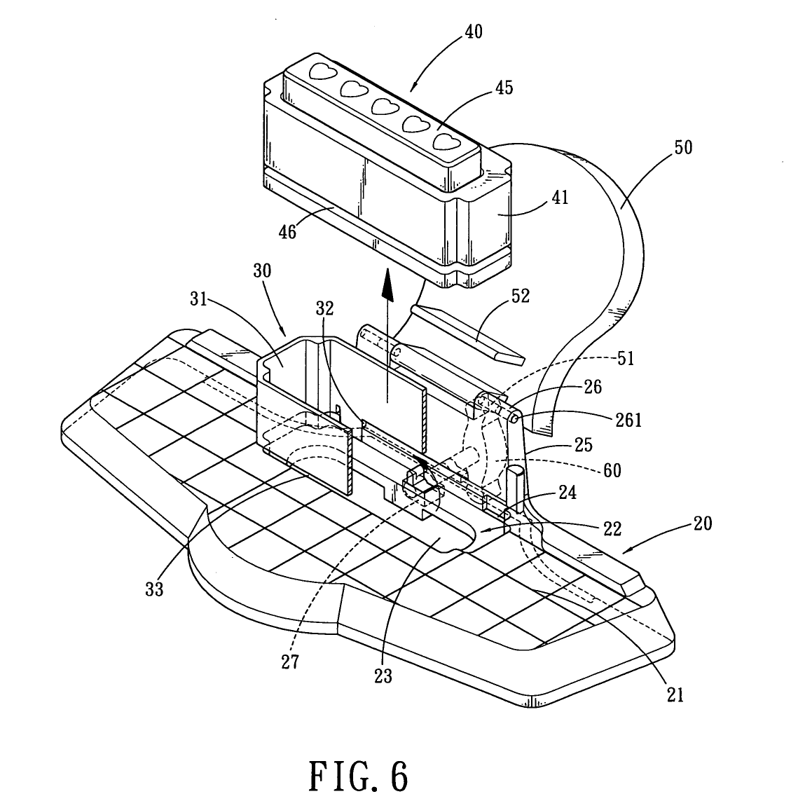

Referring again to FIG. 3, the punching die 40 in accordance with the presenting invention can be arbitrarily replaced according user's needs. To replace or assemble the punching die 40, initially the user only needs to lift the compression bar 50, as shown in FIG. 6, then the punching die 40 can be directly assembled or taken out. In other words, the consumer can buy plural punching dies 40 with lower cost, and then choose a suitable punching die 40, based on real needs, to cooperate with the basement 20.

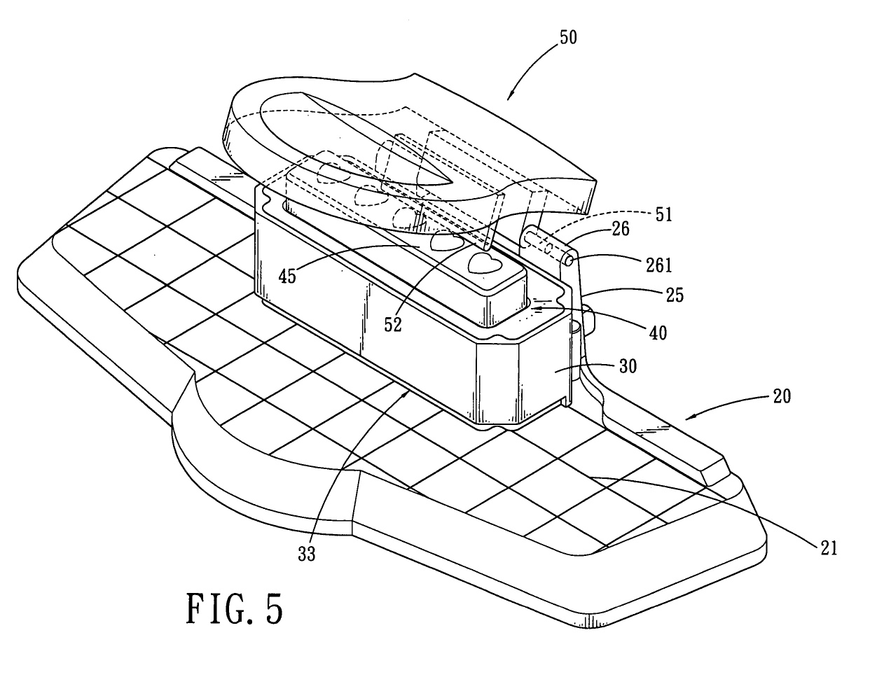

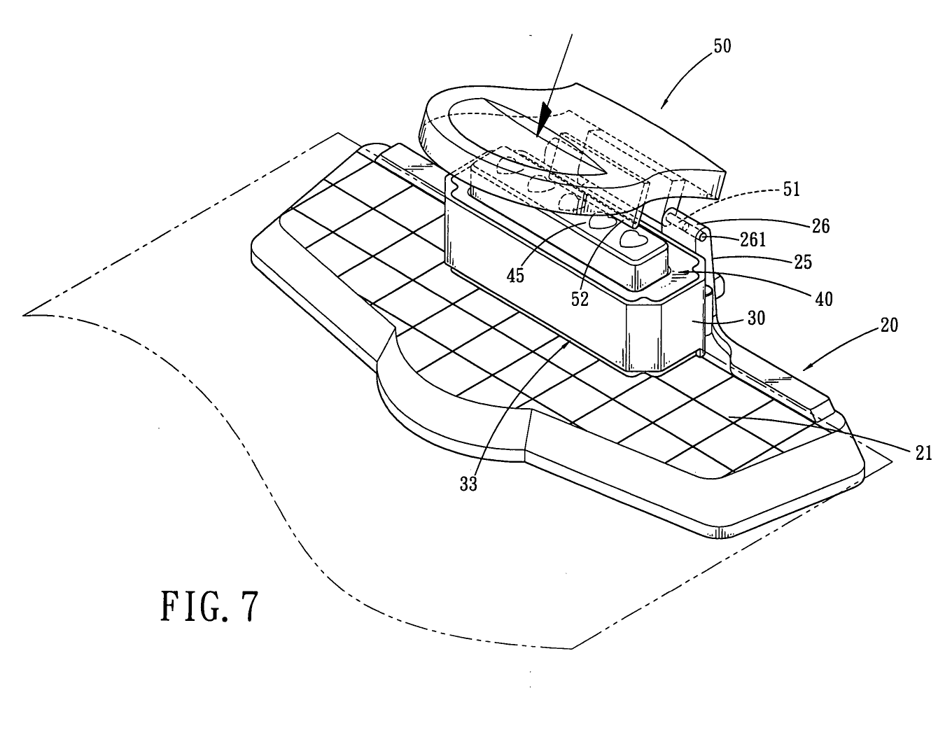

As shown in FIG. 5, after the punching die 40 is assembled to the punching device, the user can insert the to-be-punched paper to the feeding hole 46 via the crack 33 (as shown in FIG. 7), and then the paper can be punched by compressing the compression bar 50. The compression bar 50 can be compressed easily by cooperating with the punching die 40 since it is designed based on lever principle. The leftover paper can be dropped off the punching device via the through hole 23.

It is to be noted that the basement 20 in accordance with the present invention is provided with the measurement plane 21. The gauge marks on the measurement plane 21 can enable the punching holes or patterns to be punched in alignment with each other.

In addition, the punching die 40 can be taken out of the punching device when replacing it since it is directly inserted in the inserting frame 30 and located in the recess 20. However, in order to make the operation more interesting and improve the superiority of the product, on a side of the basement 20 is formed a locking hole 27 which is in communication with the recess 22. A key 60 can be inserted in the recess 22 via the locking hole 27, as shown in FIGS. 3 and 6, so that the user can raise the punching die 40 easily by rotating the key 60. As a result, the punching die 40 can be easily taken out. This operation of taking out the punching die 40 via the key is particularly easy for children.

Furthermore, the punching die 40 in accordance with the present invention can be used to punch a hole, a pattern or to press a pattern.

While we have shown and described various embodiments in accordance with the present invention, it should be clear to those skilled in the art that further embodiments may be made without departing from the scope of the present invention.

1. A punching device with replaceable punching die, comprising:
a basement, a side of which is provided with a measurement plane, a recess formed on the measurement plane, in the recess formed with a through hole and plural inserting holes, on a side of the basement adjacent to the recess formed with an assembly portion, a pair of ears respectively formed on both ends of a top edge of the assembly portion;
an inserting frame being a through frame having two open ends, peripheral wall of which is correspondingly inserted in the recess of the basement, plural hooks at lower end of the inserting frame inserted in the inserting holes, plural legs formed on the lower end of the inserting frame so that a space is formed between a side of the lower end of the inserting frame and the basement;
a punching die sequentially provided in an outer shell with a pattern knife, a spring and a die bed, a compression member disposed on top surface of the pattern knife and partially protruded out of the outer shell, a side of the outer shell formed with a feeding hole, via which, paper can be inserted to the space between the pattern knife and the die bed, the punching die can be accommodated in the inserting frame, and the die bed is aligned to the through hole inside the recess;
a compression bar respectively provided at both sides with a shaft that is used to insert in the ears of the basement, a compression rib at a bottom surface of the compression bar employed to abut against the top surface of the compression member.

2. The punching device with replaceable punching die as claimed in claim 1, wherein the measurement plane of the basement is printed with gauge marks for measuring purpose.

3. The punching device with replaceable punching die as claimed in claim 1, wherein a locking hole is formed on a side of the basement that is in communication with the recess, a key can be inserted in the recess via the locking hole, so that the user can raise the punching die easily by rotating the key.
